(19) United States
(12) Patent Application Publication
(10) Pub. No.: US 2025/0369372 A1
(43) Pub. Date: Dec. 4, 2025

(54) COMBINED CYCLE POWER PLANT WITH EXHAUST GAS RECIRCULATION EJECTOR

(71) Applicant: GENERAL ELECTRIC TECHNOLOGY GMBH, Baden (CH)

(72) Inventors: Majed SAMMAK, Schenectady, NY (US); Raub Warfield SMITH, Schenectady, NY (US); Parag Prakash KULKARNI, Schenectady, NY (US)

(21) Appl. No.: 18/998,601

(22) PCT Filed: Jul. 29, 2022
(86) PCT No.: PCT/US2022/038780

§ 371 Date: Jan. 27, 2025

(51) Int. Cl. F01K 23/10; F01K 21/04; F02C 6/18; F02C 7/12

(52) U.S. Cl. CPC F01K 23/10; F01K 21/04; F02C 6/18; F02C 7/12

(57) ABSTRACT

A combined cycle power plant includes a gas turbine engine, which includes a compressor and a turbine. The turbine discharges a first exhaust gas stream therefrom. A heat recovery steam generator receives the first exhaust gas stream, extracts heat from the first exhaust gas stream, and discharges a second exhaust gas stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards an ejector. The ejector receives the compressor extraction flow and the first portion of the cooled exhaust gas stream, compresses the first portion of the cooled exhaust gas stream using the compressor extraction flow, and discharges a recovered gas flow to the turbine.

### BACKGROUND

The present disclosure relates generally to power generation systems and, more specifically, to systems that use an ejector and recirculated exhaust gas to enhance plant output.

Gas turbine systems are used to generate power, and typically include a compressor, a combustor, and a turbine. Operation of the gas turbine system at higher operating temperatures generally results in increased performance, efficiency, and power output. However, during operation various gas path components in the system may be subjected to high temperature flows. Over time, continued exposure to high temperature flows may unduly strain the components and/or reduce their service life. Thus, at least some known gas turbine components that are subjected to high temperature flows are cooled to enable the gas turbine system to continue to operate at the increased temperatures. For example, some components may be provided with compressor bleed air, and the like, for cooling purposes. However, any air compressed in the compressor and not used to generate combustion gases generally reduces the overall efficiency and output of the gas turbine system.

### BRIEF DESCRIPTION

In one aspect, a combined cycle power plant including a gas turbine engine, which includes a compressor and a turbine, is provided. The turbine discharges a first exhaust gas stream therefrom. A heat recovery steam generator receives the first exhaust gas stream therein, extracts heat from the first exhaust gas stream, and discharges a second exhaust gas stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards an ejector. The ejector receives the compressor extraction flow from the compressor, receives the first portion of the cooled exhaust gas stream, compresses the first portion of the cooled exhaust gas stream using the compressor extraction flow, and discharges a recovered gas flow to the turbine.

In another aspect, a combined cycle power plant including a gas turbine engine, which includes a compressor and a turbine, is provided. The turbine discharges a first exhaust gas stream therefrom. A heat recovery steam generator receives the first exhaust gas stream therein, extracts heat from the first exhaust gas stream, and discharges a second exhaust gas stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards an ejector. The ejector receives the compressor extraction flow from the compressor, receives the first portion of the cooled exhaust gas stream, compresses the first portion of the cooled exhaust gas stream using the compressor extraction flow, and discharges a recovered gas flow to the turbine. A steam turbine receives the steam stream therein and discharges a steam extraction flow. A carbon capture system receives the steam extraction flow and a second portion of the cooled exhaust gas stream.

### BRIEF DESCRIPTION OF THE DRAWINGS

FIG. 1 is a schematic illustration of an exemplary combined cycle power plant.

FIG. 2 is a schematic illustration of an exemplary combined cycle power plant including an exhaust gas recirculation ejector.

FIG. 3 is an illustration of the exhaust gas recirculation ejector shown in FIG. 2.

FIG. 4 is a schematic illustration of an alternative combined cycle power plant system including an exhaust gas recirculation ejector, a second exhaust gas recirculation line, and an exhaust gas recirculation blower.

### DETAILED DESCRIPTION

The embodiments described herein relate to power generation systems that use an ejector and recirculated exhaust gas to enhance plant output and/or efficiency.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

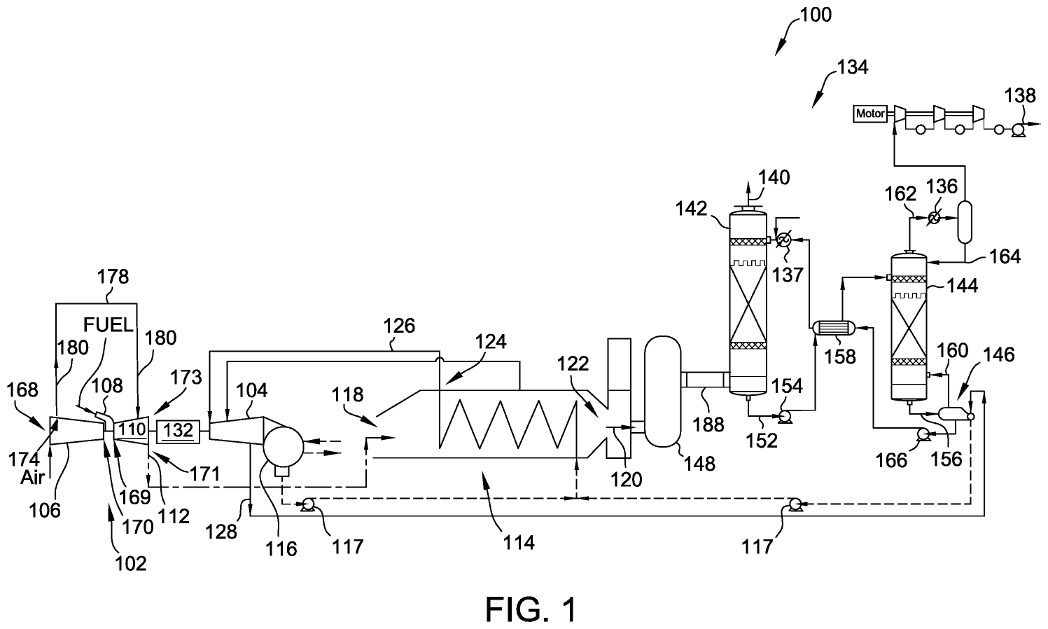

FIG. 1 is a schematic illustration of an exemplary combined cycle power plant 100. In the exemplary embodiment, power plant 100 includes a gas turbine assembly 102 and a steam turbine 104. Gas turbine assembly 102 includes a compressor 106, a combustor 108, and a turbine 110 coupled together in a serial flow relationship. In operation, combustor 108 receives air from compressor 106 and fuel from a fuel supply and mixes the fuel and air to create a fuel-air mixture that is combusted to generate combustion gases. Combustion gases are channeled through turbine 110 and discharged from turbine 110 as a first exhaust gas stream 112. In the exemplary embodiment, power plant 100 also includes a steam cycle arrangement including a heat recovery steam generator (HRSG) 114 and steam turbine 104. In some embodiments, the steam cycle arrangement may also include other components, including a condenser 116 and at least one condensate pump 117.

In the exemplary embodiment, HRSG 114 includes an inlet 118 that receives first exhaust gas stream 112 from gas turbine assembly 102. Heat is extracted from first exhaust gas stream 112, and a second exhaust gas stream 120 is discharged from a first outlet 122. Second exhaust gas stream 120 is at a lower temperature than a temperature of first exhaust gas stream 112 entering inlet 118. HRSG 114 also includes a second outlet 124 that discharges a first steam stream 126. Steam turbine 104 receives first steam stream 126 and subsequently discharges an interstage steam extraction flow 128 therefrom. Any steam not extracted with flow 128 continues expansion to condensation within condenser 116. In some embodiments, steam turbine 104 may include additional steam admissions from HRSG 114. In the exemplary embodiment, gas turbine assembly 102 and steam turbine 104 are both coupled to a generator 132 that produces power using working fluids flowing through each. Alternatively, turbine assembly 102 and steam turbine 104 may be on separate shafts, with each coupled to a separate generator.

In the exemplary embodiment, power plant 100 also includes a carbon capture system 134. During operation, carbon capture system 134 produces a carbon dioxide stream 138. Carbon capture system 134 may include one or more separators, either used alone, or in combination with other separation processes, such as carbon dioxide selective membrane technologies, absorption processes, diaphragms, and the like. An exhaust stream or carbon depleted exhaust stream 140 may be discharged from carbon capture system 134 to the ambient environment. Exhaust stream 140 may also be further processed prior to discharge to the environment or elsewhere. At least a portion of carbon dioxide stream 138 may be increased to supercritical pressure for transport and/or storage, for example.

Carbon capture system 134 generally includes an absorber 142, a stripper 144, and a stripper reboiler 146. In operation, second exhaust gas stream 120 discharged from HRSG 114 is channeled towards absorber 142. The exhaust gas may be pretreated for removal of particulates and impurities such as SOx and NOx before entry into absorber 142. In addition, in the exemplary embodiment, a first cooler 148 is coupled between HRSG 114 and carbon capture system 134. Alternatively, carbon capture system 134 may include at least one booster blower (not shown) to pressurize flow channeled towards carbon capture system 134. First cooler 148 may be, but is not limited to only being, a quench tower. First cooler 148 cools a portion of second exhaust gas stream 120 to be channeled towards carbon capture system 134.

A solvent 152, rich in carbon dioxide, is discharged from absorber 142 and is then channeled, via a pump 154, to stripper 144. Solvent 156, lean in carbon dioxide, is discharged from stripper 144 and is channeled back to an upper portion of absorber 142 via reboiler 146, a pump 166, and heat exchanger 158. Absorber 142 may be of any construction typical for providing gas-liquid contact and absorption. Absorber 142 and stripper 144 may incorporate a variety of internal components, such as trays, packings, and/or supports, for example. In one embodiment, absorber 142 absorbs carbon dioxide via a countercurrent flow from the exhaust gas entering absorber 142. Stripper 144 removes carbon dioxide from solvent 152. Absorber 142 and stripper 144 may be variably sized based on an amount of carbon dioxide to be removed, and may be variably sized according to various engineering design equations. Furthermore, a single stripper 144 may serve and be coupled to multiple absorbers 142.

In the exemplary embodiment, solvent 152 is preheated in a countercurrent heat exchanger 158 against solvent 156, and is subsequently channeled to stripper 144. Stripper 144 is a pressurized unit in which carbon dioxide is recovered from solvent 152. Stripper 144 generally incorporates reboiler 146 which receives a portion of solvent 156 exiting stripper 144. Reboiler 146 vaporizes solvent 156 and channels solvent vapor 160 back to stripper 144 to facilitate increased carbon dioxide separation. A single stripper 144 may be coupled to more than one reboiler 146. Reboiler 146 receives steam, such as from steam turbine 104 via flow 128 to provide heating duty in reboiler 146.

Vapor 162 exiting stripper 144 is partially condensed in condenser 136. The condensed portion of vapor 162 is returned to stripper 144 as reflux 164. Reflux 164 may be transferred through an accumulator (not shown) and a pump (not shown) before entry into stripper 144. Carbon dioxide stream 138 is removed from condenser 136 for transport and/or storage after compression.

In the exemplary embodiment, compressor 106 includes a compressor inlet 168, a compressor outlet 170, and a compressor extraction outlet 174. Turbine 110 includes a turbine inlet 169, a turbine outlet 171, and a turbine coolant inlet 173. Power plant 100 includes an extraction line 178 coupled between compressor 106 and turbine 110. Specifically, extraction line 178 is coupled between compressor extraction outlet 174 and turbine coolant inlet 173. Compressor 106 discharges a compressor extraction flow 180 of pressurized air towards turbine 110 through extraction line 178 to cool turbine 110.

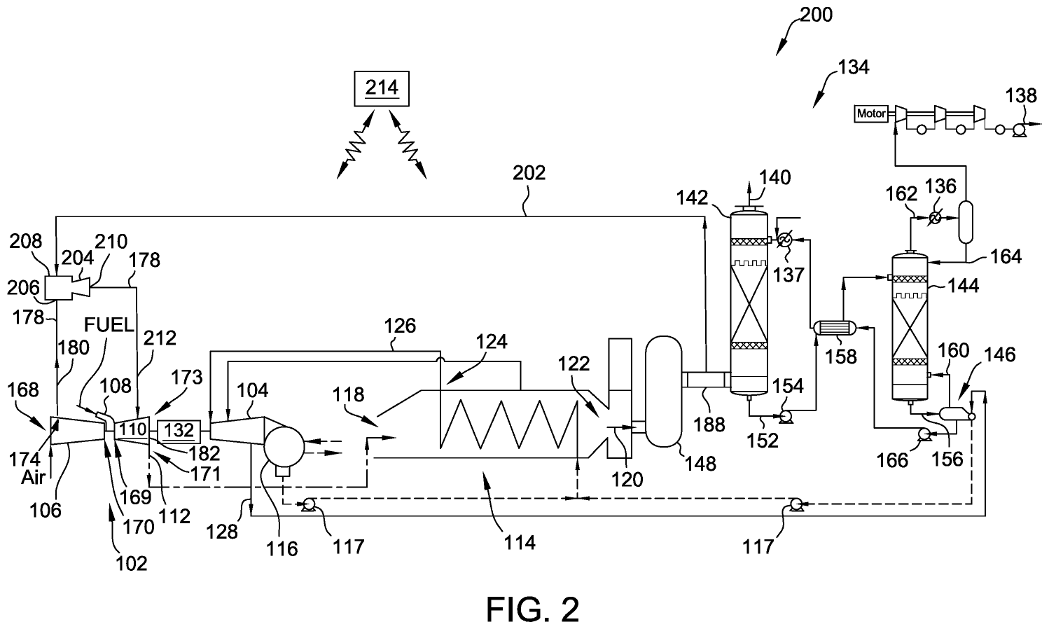

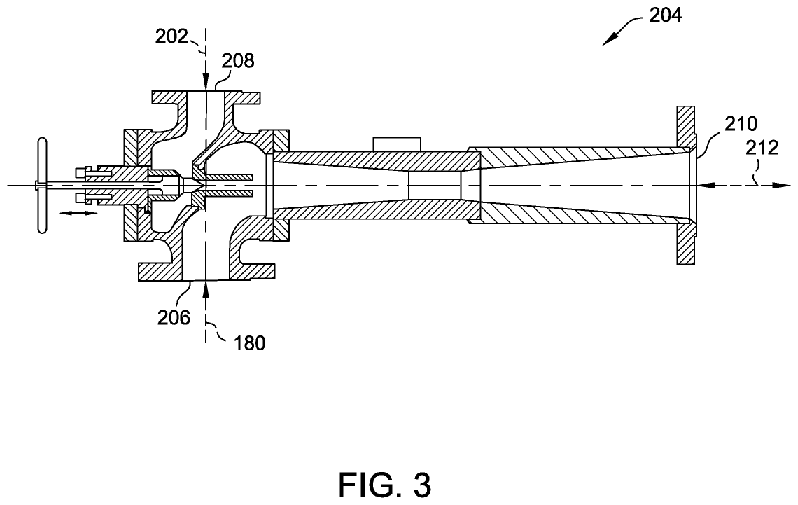

FIG. 2 is a schematic illustration of an exemplary combined cycle power plant 200. The embodiment illustrated in FIG. 2 is similar to the embodiment illustrated in FIG. 1, with the differences noted herein, below, and as such, the same reference numbers are used in FIG. 2 as were used in FIG. 1. In FIG. 2, in the exemplary embodiment, power plant 200 utilizes exhaust gas recirculation with post combustion carbon capture system 134. An exhaust gas recirculation stream 202 is drawn downstream from first cooler 148 and is channeled towards an ejector 204 (described in more detail below with reference to FIG. 3). First cooler 148 may be, but is not limited to only being, a quench tower. Ejector 204 is between compressor 106 and turbine 110 along extraction line 178. Specifically, ejector 204 is coupled between compressor extraction outlet 174 and turbine coolant inlet 173 along extraction line 178.

As shown in FIGS. 2 and 3, ejector 204 includes a first ejector inlet 206, a second ejector inlet 208, and an ejector outlet 210. First ejector inlet 206 receives compressor extraction flow 180 discharged from compressor 106 through extraction line 178 and second ejector inlet 208 receives exhaust gas recirculation stream 202. Ejector 204 uses the pressure of compressor extraction flow 180 to compress exhaust gas recirculation stream 202, wherein the pressure of compressor extraction flow 180 is higher than the operating pressure of exhaust gas recirculation stream 202. Ejector 204 discharges a recovered gas flow 212 from ejector outlet 210 through extraction line 178 to facilitate cooling turbine 110, wherein the pressure of recovered gas flow 212 is higher than the pressure of exhaust gas recirculation stream 202 and lower than the pressure of compressor extraction flow 180.

As illustrated in FIG. 1, the use of pressurized air from compressor 106 to cool turbine 110 through extraction line 178 may reduce the output of gas turbine 102, thereby causing a reduction in the output of power plant 100. The provision of exhaust gas recirculation stream 202 to ejector 204, as illustrated in FIG. 2, facilitates improving the output of gas turbine 102 by reducing an amount of pressurized air from compressor 106 needed to cool turbine 110. Exemplary power plant 200 may include a controller 214 used to dynamically adjust operation of power plant 200. For example, controller 214 may determine power consumption resulting from compressor 106 discharging compressor extraction flow 180 towards turbine 110 through extraction line 178. Accordingly, in one embodiment, flow of exhaust gas recirculation stream 202 is adjusted by controller 214 to facilitate improving the output of power plant 200. That is, controller 214 may selectively modulate the flow of exhaust gas recirculation stream 202 drawn downstream from first cooler 148 as described herein, to facilitate improving the output of power plant 200. Controller 214 facilitates extending the useful life of components within power plant 200. Thus, the flow modulation provides an option for operators of power plant 200 to use when determining how to optimize performance and life consumption of gas turbine 102.

Ejector 204 may facilitate improving the combustion stability of power plant 200. Channeling exhaust gas recirculation stream 202 to ejector 204 may facilitate an increase in the oxygen concentration and a decrease in the carbon dioxide concentration of the air received by combustor 108 from compressor 106, as compared to exhaust gas recirculation stream 202 being received by compressor 106 (not shown in Figures). That is, the combustion stability of combustor 108 may be improved by exhaust gas recirculation stream 202 bypassing combustor 108 and being channeled towards turbine 110 through extraction line 178.

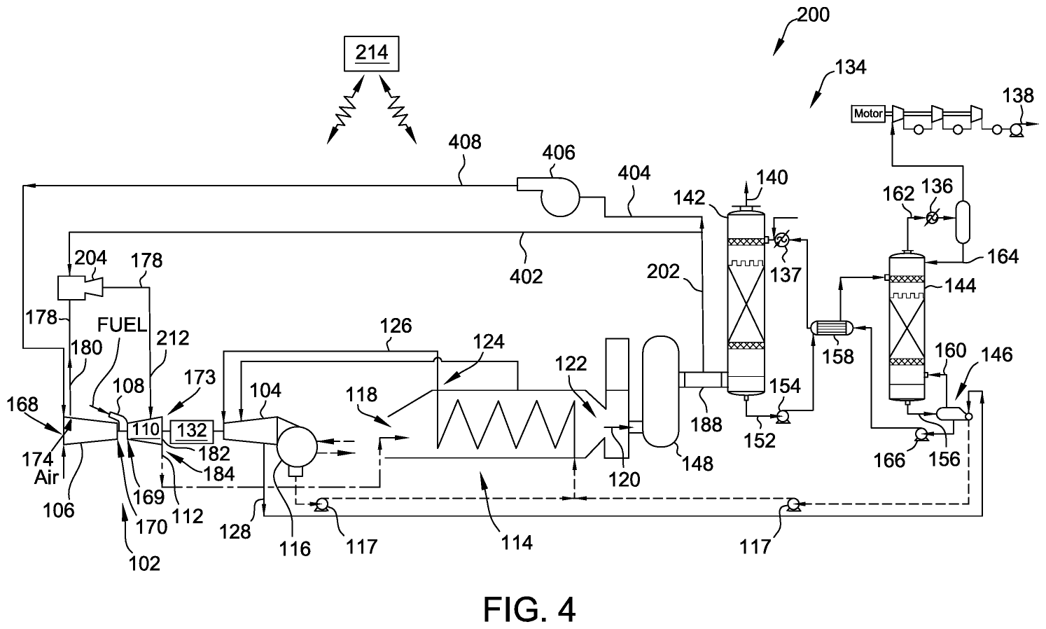

FIG. 4 is a schematic illustration of an alternative combined cycle power plant 200. The alternative embodiment illustrated in FIG. 4 is similar to the embodiment illustrated in FIG. 2, with the differences noted below, and as such, the same reference numbers are used in FIG. 4 as were used in FIG. 2. In FIG. 4, power plant 200 utilizes exhaust gas recirculation 202 with post combustion carbon capture system 134. An exhaust gas recirculation stream 202 is drawn downstream from first cooler 148 and a first portion 402 of exhaust gas recirculation stream 202 is channeled towards ejector 204. A second portion 404 of exhaust gas recirculation stream 202 is channeled towards compressor 106. A boost blower 406 is coupled between cooler 148 and compressor 106. Boost blower 406 receives second portion 404 of exhaust gas recirculation stream 202 and discharges a pressurized and cooled flow 408 towards compressor 106. Compressor 106 receives cooled flow 408 at compressor inlet 168. Both cooled flow 408 and first portion 402 of exhaust gas recirculation stream 202 improve the performance of power plant 200 by increasing the concentration of CO₂ in second exhaust gas stream 120. This reduces both the size, cost, and reboiler steam requirement via interstage steam extraction flow 128 to carbon capture system 134.

The above description is meant to be exemplary only, and one skilled in the art will recognize that changes may be made to the embodiments described without departing from the scope of the invention disclosed. Modifications, which fall within the scope of the present invention, will be apparent to those skilled in the art, in light of a review of this disclosure, and such modifications are intended to fall within the appended claims. The systems and methods described herein are not limited to the specific embodiments described herein, but rather components of the various systems may be utilized independently and separately from other systems and components described herein. For example, the exhaust gas recirculation ejector can be implemented and utilized in connection with any application where enhanced output is desired.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

Further aspects of the invention are provided by the subject matter of the following clauses:
1. A combined cycle power plant comprising: a gas turbine engine comprising: a compressor; a turbine configured to discharge a first exhaust gas stream therefrom; a heat recovery steam generator configured to: receive the first exhaust gas stream therein; extract heat from the first exhaust gas stream: and discharge a second exhaust gas stream therefrom; a cooler configured to cool the second exhaust gas stream, thereby defining a cooled exhaust gas stream, wherein the cooler discharges the cooled exhaust gas stream; and an exhaust gas recirculation line configured to channel a first portion of the cooled exhaust gas stream towards an ejector, wherein the ejector is configured to: receive a compressor extraction flow from the compressor; receive the first portion of the cooled exhaust gas stream; compress the first portion of the cooled exhaust gas stream using the compressor extraction flow; and discharge a recovered gas flow to the turbine.
2. The combined cycle power plant in accordance with Claim 1 further comprising: the heat recovery steam generator configured to discharge a steam stream: a steam turbine configured to: receive the steam stream therein; and discharge a steam extraction flow; a carbon capture system configured to receive the steam extraction flow: and a controller configured to modulate the flow of the cooled exhaust gas stream recirculated towards the ejector to facilitate increasing an output of the combined cycle power plant.
3. The combined cycle power plant in accordance with Claim 2, wherein the controller is further configured to: determine power consumption resulting from discharging the compressor extraction flow from the compressor; and modulate the flow of the cooled exhaust gas stream recirculated towards the ejector to facilitate increasing the output of the combined cycle power plant.
4. The combined cycle power plant in accordance with Claim 2, wherein the controller is further configured to: monitor a temperature of the turbine; and modulate the flow of the cooled exhaust gas stream recirculated towards the ejector to facilitate part life consumption management of the gas turbine engine.
5. The combined cycle power plant in accordance with Claim 1, wherein the compressor extraction flow is of a first pressure measurement, the cooled exhaust gas stream is of a second pressure measurement, and the recovered gas flow is of a third pressure measurement, wherein the second pressure measurement is lower than the first pressure measurement, and the third pressure measurement is lower than the first pressure measurement and higher than the second pressure measurement.
6. The combined cycle power plant in accordance with Claim 2 further comprising the carbon capture system configured to receive a second portion of the cooled exhaust gas stream.
7. The combined cycle power plant in accordance with Claim 1 further comprising a second exhaust gas recirculation line configured to channel a third portion of the cooled exhaust gas stream towards the compressor.
8. The combined cycle power plant in accordance with Claim 7 further comprising an exhaust gas boost blower configured to channel the third portion of the cooled exhaust gas stream towards the compressor.
9. A combined cycle power plant comprising: a gas turbine engine comprising: a compressor; a turbine configured to discharge a first exhaust gas stream therefrom; a heat recovery steam generator configured to: receive the first exhaust gas stream therein; extract heat from the first exhaust gas stream; and discharge a second exhaust gas stream and a steam stream therefrom; a cooler configured to cool the second exhaust gas stream, thereby defining a cooled exhaust gas stream, wherein the cooler discharges the cooled exhaust gas stream; an exhaust gas recirculation line configured to channel a first portion of the cooled exhaust gas stream towards an ejector, wherein the ejector is configured to: receive a compressor extraction flow from the compressor; receive the first portion of the cooled exhaust gas stream: compress the first portion of the cooled exhaust gas stream using the compressor extraction flow; and discharge a recovered gas flow to the turbine: a steam turbine configured to: receive the steam stream therein; and discharge a steam extraction flow; and a carbon capture system configured to receive the steam extraction flow.
10. The combined cycle power plant in accordance with Claim 9 further comprising a controller configured to: determine power consumption resulting from discharging the compressor extraction flow from the compressor; and modulate the flow of the cooled exhaust gas stream recirculated towards the ejector to facilitate increasing an output of the combined cycle power plant.
11. The combined cycle power plant in accordance with claim 10, wherein the controller is further configured to: monitor a temperature of the turbine: and modulate the flow of the cooled exhaust gas stream recirculated towards the ejector to facilitate part life consumption management of the gas turbine engine.
12. The combined cycle power plant in accordance with Claim 9 further comprising the carbon capture system configured to receive a second portion of the cooled exhaust gas stream.
13. The combined cycle power plant in accordance with Claim 9, wherein the compressor extraction flow is of a first pressure measurement, the cooled exhaust gas stream is of a second pressure measurement, and the recovered gas flow is of a third pressure measurement, wherein the second pressure measurement is lower than the first pressure measurement, and the third pressure measurement is lower than the first pressure measurement and higher than the second pressure measurement.
14. The combined cycle power plant in accordance with Claim 9 further comprising a second exhaust gas recirculation line configured to channel a third portion of the cooled exhaust gas stream towards the compressor.
15. The combined cycle power plant in accordance with Claim 14 further comprising an exhaust gas boost blower configured to channel the third portion of the cooled exhaust gas stream towards the compressor.

While the invention has been described in terms of various specific embodiments, those skilled in the art will recognize that the invention can be practiced with modification within the spirit and scope of the claims.

1. A combined cycle power plant comprising:
a gas turbine engine comprising:
a compressor;
a turbine configured to discharge a first exhaust gas stream therefrom;
a heat recovery steam generator configured to:
receive the first exhaust gas stream therein;
extract heat from the first exhaust gas stream; and
discharge a second exhaust gas stream therefrom;
a carbon capture system downstream of the heat recovery steam generator;
a cooler coupled between the heat recovery steam generator and the carbon capture system, the cooler configured to cool the second exhaust gas stream, thereby defining a cooled exhaust gas stream, wherein the cooler discharges the cooled exhaust gas stream; and
an exhaust gas recirculation line in flow communication with a conduit coupling the cooler and the carbon capture system, the exhaust gas recirculation line configured to channel a first portion of the cooled exhaust gas stream towards an ejector, wherein the ejector is configured to:
receive a compressor extraction flow from the compressor;
receive the first portion of the cooled exhaust gas stream;
compress the first portion of the cooled exhaust gas stream using the compressor extraction flow; and
discharge a recovered gas flow to the turbine.

2. The combined cycle power plant in accordance with claim 1 further comprising:
the heat recovery steam generator configured to discharge a steam stream;
a steam turbine configured to:
receive the steam stream therein; and
discharge a steam extraction flow, wherein the carbon capture system is configured to receive the steam extraction flow; and
a controller configured to modulate the flow of the cooled exhaust gas stream recirculated towards the ejector to facilitate increasing an output of the combined cycle power plant.

3. The combined cycle power plant in accordance with claim 2, wherein the controller is further configured to:
determine power consumption resulting from discharging the compressor extraction flow from the compressor; and
modulate the flow of the cooled exhaust gas stream recirculated towards the ejector to facilitate increasing the output of the combined cycle power plant.

4. The combined cycle power plant in accordance with claim 2, wherein the controller is further configured to:
monitor a temperature of the turbine; and
modulate the flow of the cooled exhaust gas stream recirculated towards the ejector to facilitate part life consumption management of the gas turbine engine.

5. The combined cycle power plant in accordance with claim 1, wherein the compressor extraction flow is of a first pressure measurement, the cooled exhaust gas stream is of a second pressure measurement, and the recovered gas flow is of a third pressure measurement, wherein the second pressure measurement is lower than the first pressure measurement, and the third pressure measurement is lower than the first pressure measurement and higher than the second pressure measurement.

6. The combined cycle power plant in accordance with claim 1 further comprising the carbon capture system configured to receive a second portion of the cooled exhaust gas stream.

7. The combined cycle power plant in accordance with claim 1 further comprising a second exhaust gas recirculation line configured to channel a third portion of the cooled exhaust gas stream towards the compressor.

8. The combined cycle power plant in accordance with claim 7 further comprising an exhaust gas boost blower configured to channel the third portion of the cooled exhaust gas stream towards the compressor.

9. A combined cycle power plant comprising:
a gas turbine engine comprising:
a compressor;
a turbine configured to discharge a first exhaust gas stream therefrom;
a heat recovery steam generator downstream and in flow communication with the gas turbine engine, the heat recovery steam generator configured to:
receive the first exhaust gas stream therein;
extract heat from the first exhaust gas stream; and
discharge a second exhaust gas stream and a steam stream therefrom;
a carbon capture system downstream of the heat recovery steam generator;
a cooler fluidly coupling the heat recovery steam generator and the carbon capture system, the cooler configured to cool the second exhaust gas stream, thereby defining a cooled exhaust gas stream, wherein the cooler discharges the cooled exhaust gas stream;
an exhaust gas recirculation line in flow communication with a conduit coupling the cooler and the carbon capture system;
an ejector in flow communication with the exhaust gas recirculation line and coupled between the compressor and the turbine of the gas turbine engine, wherein the ejector is configured to:
receive a compressor extraction flow from the compressor;
receive a first portion of the cooled exhaust gas stream from the exhaust gas recirculation line;
compress the first portion of the cooled exhaust gas stream using the compressor extraction flow; and
discharge a recovered gas flow to the turbine;
a steam turbine configured to:
receive the steam stream therein; and
discharge a steam extraction flow, wherein the carbon capture system is configured to receive the steam extraction flow.

10. The combined cycle power plant in accordance with claim 9 further comprising a controller configured to:
determine power consumption resulting from discharging the compressor extraction flow from the compressor; and
modulate the flow of the cooled exhaust gas stream recirculated towards the ejector to facilitate increasing an output of the combined cycle power plant.

11. The combined cycle power plant in accordance with claim 10, wherein the controller is further configured to:
monitor a temperature of the turbine; and
modulate the flow of the cooled exhaust gas stream recirculated towards the ejector to facilitate part life consumption management of the gas turbine engine.

12. The combined cycle power plant in accordance with claim 9 further comprising the carbon capture system configured to receive a second portion of the cooled exhaust gas stream.

13. The combined cycle power plant in accordance with claim 9, wherein the compressor extraction flow is of a first pressure measurement, the cooled exhaust gas stream is of a second pressure measurement, and the recovered gas flow is of a third pressure measurement, wherein the second pressure measurement is lower than the first pressure measurement, and the third pressure measurement is lower than the first pressure measurement and higher than the second pressure measurement.

14. The combined cycle power plant in accordance with claim 9 further comprising a second exhaust gas recirculation line configured to channel a third portion of the cooled exhaust gas stream towards the compressor.

15. The combined cycle power plant in accordance with claim 14 further comprising an exhaust gas boost blower configured to channel the third portion of the cooled exhaust gas stream towards the compressor.
